(19) United States
(12) Patent Application Publication
(10) Pub. No.: US 2025/0201218 A1
(43) Pub. Date: Jun. 19, 2025

(54) SYSTEM AND METHODS FOR MUSIC RECOGNITION, MODIFICATION, INSTRUMENT MUTING AND MUSIC STORAGE

(71) Applicant: Vidhur Seshadri, Austin, TX (US)

(72) Inventor: Vidhur Seshadri, Austin, TX (US)

(21) Appl. No.: 18/885,292

(22) Filed: Sep. 13, 2024

Related U.S. Application Data
(60) Provisional application No. 63/610,191, filed on Dec. 14, 2023.
(60) Provisional application No. 63/610,958, filed on Dec. 15, 2023.

(51) Int. Cl. G10H 1/00

(52) U.S. Cl. CPC G10H 1/0025; G10H 1/0033; G10H 2210/056; G10H 2210/381; G10H 2240/141

(57) ABSTRACT

A computer-implemented method for providing a holistic music experience is disclosed. The method includes receiving musical input from users, transforming the input into an identifiable melody using a unique identification algorithm, and matching the melody against a database of musical compositions. Information about the matched musical composition is retrieved and displayed. User instructions to alter the tone or speed of the matched musical composition are received and implemented. A specific musical device can be silenced based on user instructions. The method also includes receiving user-submitted written music, capturing personalized audio and visual recordings, and displaying these recordings to a global audience.

### CROSS-REFERENCE TO RELATED APPLICATION(S)

The present application claims the benefit of priority to U.S. Provisional Application No. 63/610,958, filed Dec. 15, 2023, as well as claims the benefit of priority to U.S. Provisional Application No. 63/610,191, filed Dec. 14, 2023, all sections of the aforementioned application(s) and/or patent(s) are incorporated herein by reference in their entirety.

### TECHNICAL FIELD OF DISCLOSURE

The present disclosure relates generally to the field of music and pertains to a comprehensive music software embodying systems and methods of the disclosure herein that integrates song identification, modification, instrument muting, music sheet uploading, and song recording into a single platform, primarily aimed at music learners and enthusiasts.

### BACKGROUND

The field of music has always been a source of joy and inspiration for many. It is a universal language that transcends borders and cultures, connecting people on a deep emotional level. However, for those who wish to learn and create music, there are several challenges that they often face.

One of the main challenges is that people hear songs that interest them and don't have much information on how to go about learning and creating the song or the music. Some of these people are even musicians and want to improvise a certain part of the song and build on it. However, first, they have to look up the song, which is often needlessly complicated, and then find the music sheets that correlate to their interests, which can become expensive. On top of this, having to re-record the song with the musician's custom playing, is tedious and sometimes harrowingly difficult, as it requires multiple devices to perform different tasks or specialized applications. Many applications today use outdated or inefficient methods, which can lead to frustrating user experiences and a poor output quality. More often than not, these apps do not have a contingency plan or backup alternative in case something fails, which can lead the user to potentially lose hours of work.

Another challenge is the process of identifying a song and finding the corresponding music sheets. This process can be time-consuming and often requires the use of multiple devices or applications. Additionally, music sheets can be expensive, making it a costly endeavor for those who wish to learn multiple songs. Today we have many music apps that help people identify the song and provide lyrics. There are an odd assortment of apps which also provide services of providing music sheets based on search, and apps which can mute or change the volume of instruments. However, the challenge faced by people is they have to switch between apps, pay subscription for each service and not get the most accurate and comprehensive results. Music sheets are also very expensive. This can get frustrating and difficult for learners.

Another challenge is the process of improvising or customizing a song. Musicians often wish to add their own touch to a song by improvising certain parts. However, this requires a deep understanding of the song's structure and the ability to isolate different instruments, which can be difficult for beginners.

Furthermore, the process of recording a customized version of a song can be tedious and complex. It often requires the use of specialized applications and multiple devices, which can lead to a frustrating user experience and poor output quality.

Moreover, many of the existing music applications use outdated or inefficient methods, leading to subpar user experiences. These applications often lack a backup plan in case something fails, potentially causing the user to lose hours of work.

In addition, the need to switch between different applications and pay for multiple subscriptions can be frustrating and expensive. This is especially true for learners who require comprehensive and accurate results to improve their skills.

Overall, while music is a source of joy and inspiration, the process of learning and creating music can be fraught with challenges. These challenges include the difficulty of identifying songs and finding music sheets, the complexity of improvising and recording customized versions of songs, and the inefficiencies of existing music applications.

### SUMMARY

In accordance with embodiments, a computer-implemented method is provided for offering a comprehensive music experience. The method involves receiving a musical input from one or more users and converting this input into a recognizable melody using a unique identification algorithm. This melody is then matched against a database of musical compositions stored in a digital storage space. Information about the matched musical composition, including the title, performer or group of performers, and associated musical devices, is retrieved and displayed on a visual output device. The method also allows for user instructions to alter the tone or speed of the matched musical composition, and to silence a specific musical device. Additionally, the method includes receiving written music submitted by the user, capturing personalized audio and visual recordings using an integrated recording feature, and displaying these recordings to a global audience.

In accordance with other embodiments, a computer-implemented method is provided for offering a comprehensive music experience. The method involves receiving a musical input from one or more users and converting this input into a recognizable melody using a unique identification algorithm. This melody is then matched against a database of musical compositions stored in a digital storage space. Information about the matched musical composition, including the title, performer or group of performers, and associated musical devices, is retrieved and displayed on a visual output device. The method also allows for user instructions to alter the tone or speed of the matched musical composition, and to silence a specific musical device. Additionally, the method includes receiving written music submitted by the user, capturing personalized audio and visual recordings using an integrated recording feature, and displaying these recordings to a global audience.

In accordance with embodiments, a method is provided for modifying audio content. The method involves receiving one or more audio signals and transforming these signals from a temporal domain to a spectral domain using one or more spectral transformation methods. The spectral components are then decomposed into specific spectral elements using a phase adjustment process. Specific spectral bins are grouped using an audio reconstruction process. The original audio content is reconstructed with altered audio property using reverse spectral transformation methods. Audio alteration algorithms are implemented in these reverse spectral transformation methods.

In accordance with other embodiments, a system is provided for modifying audio content. The system comprises components (e.g., hardware including processor(s) and/or software) or means for receiving one or more audio signals, components (e.g., hardware including processor(s) and/or software) or means for transforming the audio signals from a temporal domain to a spectral domain using one or more spectral transformation methods, components (e.g., hardware including processor(s) and/or software) or means for decomposing spectral components into specific spectral elements using a phase adjustment process, components (e.g., hardware including processor(s) and/or software) or means for grouping specific spectral bins using an audio reconstruction process, components (e.g., hardware including processor(s) and/or software) or means for reconstructing original audio content with altered audio property using reverse spectral transformation methods, and components (e.g., hardware including processor(s) and/or software) or means for implementing audio alteration algorithms in reverse spectral transformation methods.

In accordance with embodiments, a computer-implemented method is provided for offering a holistic music experience. The method involves receiving musical input from users through electronic equipment and using a music recognition and modification software to process the musical compositions. The musical composition is transformed into a visual representation of frequencies using a music identification algorithm, which is then converted into numerical data. This data is compared with a database of musical compositions stored in a digital storage system. The musical sequences and musical composition information are displayed on a visual output device. The tone of the musical composition is modified using a pitch modification technique and frequency ranges are generated using a frequency analysis technique. Certain frequency ranges are eliminated to mute specific musical devices in the musical composition. Users can submit written music and capture and submit audio with the musical composition using a web-based audio capture tool. The captured audio is stored in a data storage and processing system.

In accordance with other embodiments, a computer-implemented system is provided for offering a holistic music experience. The system comprises electronic equipment configured to receive a musical input from users, a music recognition and modification software to process the musical compositions, a music identification algorithm to transform the musical composition into a visual representation of frequencies, a transformation module to convert the visual representation of frequencies into numerical data, and a comparison module to compare the numerical data with a database of musical compositions stored in a digital storage system. The system also includes a visual output device to display the musical sequences and musical composition information, a pitch modification technique to modify the tone of the musical composition, a frequency analysis technique to generate frequency ranges, a muting module to eliminate certain frequency ranges to mute specific musical devices in the musical composition, a submission module to allow users to submit written music, a data retrieval method to obtain the written music, a web-based audio capture tool to allow users to capture and submit audio with the musical composition, and a data storage and processing system to store the captured audio.

In yet other embodiments, the method and system can be further enhanced by integrating a machine learning technique into the music recognition and modification software, enabling users to provide musical information, employing the machine learning technique to identify the musical information, supplying a publicly available algorithm for music identification, containing the musical composition data in a cloud storage service, supplying music recognition through a video sharing platform, obtaining the musical composition information using internet-based services, showing the stored musical composition data in a software interaction point, transforming time sampled data into complex amplitudes with equal frequencies using a frequency analysis technique, generating the original musical composition with an altered tone using a time domain conversion technique, eliminating rates of vibration below a certain level using a frequency filter, removing a sound amplification phenomenon using a sound adjustment tool, employing a programming resource for personalized programming, employing a sound examination library for audio analysis, performing the submission of written music by the users, obtaining the written music using a search-friendly data retrieval method, and performing the audio capture process by the users.

### BRIEF DESCRIPTION OF THE DRAWINGS

FIG. 1 provides an exemplary schematic diagram of the software embodying systems and methods of the disclosure herein that provides various exemplary steps through the components in accordance with certain embodiments.

FIG. 2 illustrates, in a flowchart, operations for providing a holistic music experience in accordance with certain embodiments.

FIG. 3 illustrates, in a block diagram, systems for providing a breakdown of various aspects of subject matter in accordance with certain embodiments.

FIG. 4 illustrates, in a block diagram, for providing a holistic music experience in accordance with certain embodiments.

FIG. 5 provides a block diagram of UI components in accordance with certain embodiments.

FIG. 6 provides an exemplary schematic diagram of the various technological processes with the components of the software embodying systems and methods of the disclosure herein in accordance with certain embodiments.

FIG. 7 illustrates, in a flowchart, operations for modifying a song using Fast Fourier Transforms in accordance with certain embodiments.

FIG. 8 illustrates, in a flowchart, operations for modifying a melody using spectral transformation and pitch modification algorithms in accordance with certain embodiments.

FIG. 9 illustrates, in a block diagram, systems for modifying a melody using spectral transformation and pitch modification algorithms in accordance with certain embodiments.

FIG. 10 illustrates, in a block diagram, a method that can modify a song using various techniques for conversion, transformation, grouping, recreation, and implementation in accordance with certain embodiments.

FIG. 11 illustrates, in a block diagram, systems for recreating the song with modified melody and audio input with the aid of phase and temp shifting algorithm in accordance with certain embodiments.

FIG. 12 illustrates, in a flowchart, operations for muting an instrument using splicing, filtering and sweeping in accordance with certain embodiments.

FIG. 13 illustrates, in a flowchart, operations for uploading a music sheet that is verified by a user in accordance with certain embodiments.

FIG. 14 illustrates, in a flowchart, operations for recording a song with instrument of choice mixed in accordance with certain embodiments.

FIG. 15 illustrates, in a block diagram, a computer-implemented system for providing a holistic music experience in accordance with certain embodiments.

FIG. 16 illustrates a different schema of block diagrams, for providing a holistic music experience in accordance with certain embodiments.

### DETAILED DESCRIPTION OF THE EMBODIMENTS

This disclosure, among other aspects, provides for a process that listens to a tune from a user(s) and identifies the song from the dictionary of songs stored in the cloud and gives information about it including the artist, song name, lyrics, instruments that can be isolated, and provides music sheets per instrument and can have people upload videos of themselves performing the song to be part of a daily showcase and incorporated into an easily accessible application. The process utilizes principles of deep learning to be incorporated into an application which allows the user to input music data and will recognize various audiological and components of set data including frequency, tempo, pitch to recognize discrete instruments used for the purpose of creating a graphical representation of the music displayed in the application.

The software embodying systems and methods of the disclosure herein is an app, available on any number of devices, where people may learn a new instrument and can find easy songs with music and tracks available. It is convenient for finding songs per instrument. For example, casual listeners who hear a song that has a nice instrument piece or a solo can now listen to just that portion of the song/instrument with emphasis. Using the app avoids the difficulty of identifying a song, then looking it up, then buying the music sheet or backing tracks. Additionally, in a professional recording—using this app musicians may find a nice instrument part and then incorporate that part in their song. It is also an easy way of finding sheet music for band performance. The app would be readily available for any popular operating system devices such as Apple and Android devices, and other similar systems.

The software, embodying systems and methods of the disclosure herein, which is run on a client server environment, is an application that solves the need of providing a holistic all in one experience for any music lover or music aspirant at a very affordable price. The client-server environment may include handheld devices, servers with CPUs, GPU, other processors, and a variety of computer components. It is a music app that will provide the following capability for a user when she or he hums a song or plays on a radio. The software embodying systems and methods of the disclosure herein provides the following capabilities for an user: (a) Song Identification: Identify songs by listening and provide the details of the song such as song name, singer's name, listing of instruments in the song, and so forth; (b) Song Modification: change pitch/key of song, change temp, and so forth; (c) Instrument Muting: list all the instruments that are in play, and the capability to mute the instrument of interest so that the user can karaoke his instrument with the rest of the music; (d) Music Sheet Uploading/Retrieval: list all the instruments that are in play, users can upload music sheets for the instrument of choice, music sheets are community verified for accuracy; (e) Inbuilt Recording: Record and upload voice with track, and showcase to people around the world. The devices and methods to be employed are not limited by this list but what is suitable in a particular implementation, including deploying suitable software components in suitable hardware.

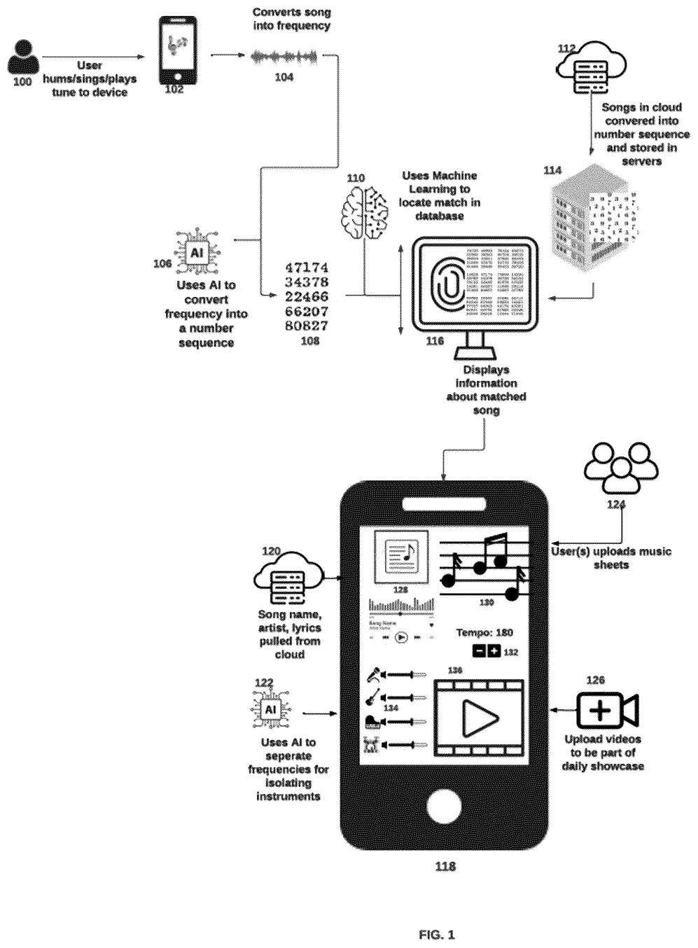

As described in FIG. 1 above, users may hum a tune or play a song from any device (100) such as radio, or from other commercially available music/video platforms such as YouTube etc.

The microphone on any device: laptop, desktop or handheld (102) takes in the input and feeds into the software application embodying systems and methods of the disclosure herein. The software embodying systems and methods of the disclosure herein listens to the songs through an application that is cached in any device (Laptop, handheld or desktop) to convert the input into a recognizable tune. The song or hum is converted into a set of frequencies (104) using a fingerprinting algorithm which is fully machine learned. The algorithm converts the song into a spectrogram using deep learning (106), which in turn is converted into sequence of numbers or digitized data (108), and matches against the existing list of songs using AI based deep learning techniques (110) in the server/cloud storage (112/114). The display (116) is used to list the song patterns that are retrieved from the storage as a possible match to the song queried. Once there is a song match, song name, singer/s, list of instruments and music sheet (if available) is retrieved. The accuracy level of the match also is displayed in the application.

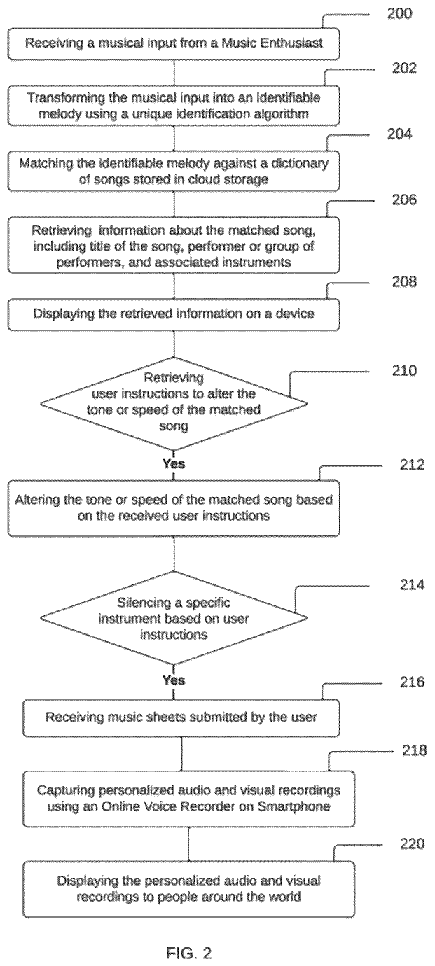

As described in FIG. 2 above, the software embodying systems and methods of the disclosure herein is an application that solves the need of providing a holistic all in one experience for any music lover or music enthusiast at a very affordable price or low cost environment. It is a music app that will provide the following capability for a user when she or he hums a song or plays on a radio. The software embodying systems and methods of the disclosure herein provides the following capabilities for an user: (a) Song Identification: Identify songs by listening and provide the details of the song such as song name, singer's name, listing of instruments in the song, and so forth; (b) Song Modification: change pitch/key of song, change temp, and so forth; (c) Instrument Muting: list all the instruments that are in play, and the capability to mute the instrument of interest so that the user can karaoke his instrument with the rest of the music; (d) Music Sheet Uploading/Retrieval: list all the instruments that are in play, users can upload music sheets for the instrument of choice, music sheets are community verified for accuracy; (e) Inbuilt Recording: Record and upload voice with track, and showcase to people around the world. The devices and methods to be employed are not limited by this list but what is suitable in a particular implementation, including deploying suitable software components in suitable hardware.

As described in FIG. 2 above, aspects of one embodiment are now provided on how the systems and methods function:

In step 200, a music student, for instance, provides a musical input. This could be humming a tune or playing a part of a song on an instrument. The input is captured using a microphone on a device, such as a smartphone or other smart device. The quality of the input depends on the clarity of the sound captured by the microphone. These devices are well known to those skilled in the art.

In step 202, the music recognition software component, like EchoPrint, transforms the musical input into an identifiable melody. This is done by analyzing the frequency, pitch, and tempo of the input and comparing it with a database of known melodies. The output is a digital representation of the melody that can be matched against a database.

Step 204 involves matching the identifiable melody against a dictionary of songs stored in the cloud. This could be a database like MySQL that contains a vast collection of songs. The matching process involves comparing the digital representation of the melody with the digital representations of songs in the database. The success of this step depends on the accuracy of the transformation in step 102 and the comprehensiveness of the song database. In step 206, information about the matched song is retrieved. This includes the title of the song, the performer or group of performers, and the associated instruments. This information is stored in the song database and is retrieved using a search algorithm. The accuracy of the information depends on the quality of the data in the database.

Step 208 involves displaying the retrieved information on a device. This could be a laptop screen, for instance. The information is displayed in a user-friendly format, allowing the user to easily understand the details of the song.

In step 210, the music student provides instructions to alter the tone and/or speed of the matched song. This could involve increasing and/or decreasing the duration, pitch, tempo, intensity, and/or timbre of the song. The music recognition software component embodies systems and methods of the disclosure herein interprets these instructions and applies the necessary modifications to the digital representation of the song.

Step 212 involves altering the tone or speed of the matched song based on the received user instructions. The music recognition software component, using an AI engine, like TensorFlow, AI neural networks, large language models (LLM) and the like, applies the modifications to the digital representation of the song. The output is a modified digital representation of the song that reflects the changes in tone and/or speed.

In step 214, a specific instrument(s) is silenced based on user instructions. This involves identifying the frequencies associated with the specific instrument and removing them from the digital representation of the song. This could be done using a Python Library like Librosa, which provides tools for audio analysis and manipulation. In one or more embodiments, a student is able to solely hear their instrument's part (e.g., for them to learn their part easier) and to add their version of the instrument to the original piece (e.g., for performing or recording purposes).

In step 216, the music student submits music sheets. These are written representations of music, such as Guitar Tablature, that provide a visual guide for playing the song. The music sheets are uploaded to the music recognition software component embodying systems and methods of the disclosure herein and stored in the database. In one or more embodiments, a repository of music sheets can be created to help students get easier access to learning chord, notes, lyrics and instructions to play the instrument.

Step 218 involves capturing personalized audio and visual recordings using an inbuilt recording feature. The music student performs the song, and the performance is recorded using the microphone and camera on the device. The quality of the recording depends on the quality of the microphone and camera, as well as the performance of the music student. In one or more embodiments, a student's performance and recording thereof can occur while the software is playing a matched musical composition (e.g., which may be altered as to tempo/speed and may be altered by silencing an instrument). In one or more embodiments, the performance by the music student can be of a silenced musical device. For example, muting of the instrument can be used for the music student to fill in their version of the instrument into the original song. For instance, a drummer can mute the drums and play that piece as a part of a learning exercise. In one or more embodiments, the system and methods described herein can facilitate musicians producing recordings. For instance, musicians can insert their version of the part into the music recording if it has been altered (e.g., a student mutes vocals, records themselves singing the part, and now has a recording which is original recording with alterations and has the student's vocals). In one or more embodiments, to achieve a better recording experience, an option can be provided to play musical recordings (with any alterations) for the student while recording to make it easier for them to record.

Finally, in step 220, the personalized audio and visual recordings are displayed to people around the world. This could be done through a video sharing platform like YouTube. The recordings are uploaded to the platform and made available for viewing by a global audience. The success of this step depends on the quality of the recording and the reach of the video sharing platform. In one embodiment, multiple recordings by the student can be uploaded to the platform and/or can be selectively included in the presentation, such as repeating the silencing and recording steps so that the student plays drums in a first recording, plays guitar in a second recording, plays piano in a third recording and provides vocals in a fourth recording. In one embodiment, a viewer can then decide the particular playback they want including combinations such as the student both singing and playing piano in the playback. The system and methodology described herein can provide for selectively choosing the instrument you want to mute and uploading multiple recordings of the same piece.

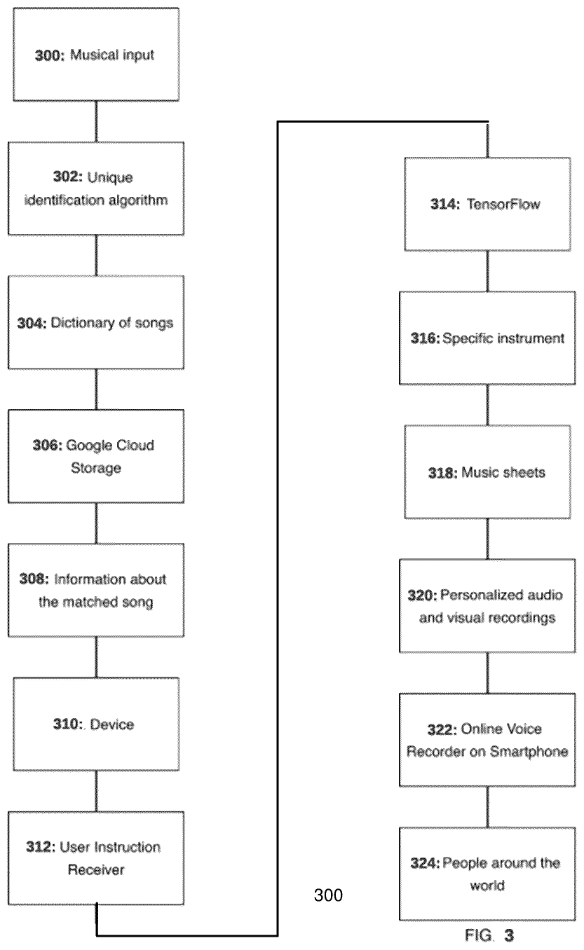

An embodiment is described in FIG. 3 above, illustrates systems and methods of the disclosure herein, showing in a block diagram form various aspects. Each of the blocks have been previously described with respect to the corresponding flow charts in FIG. 2 above.

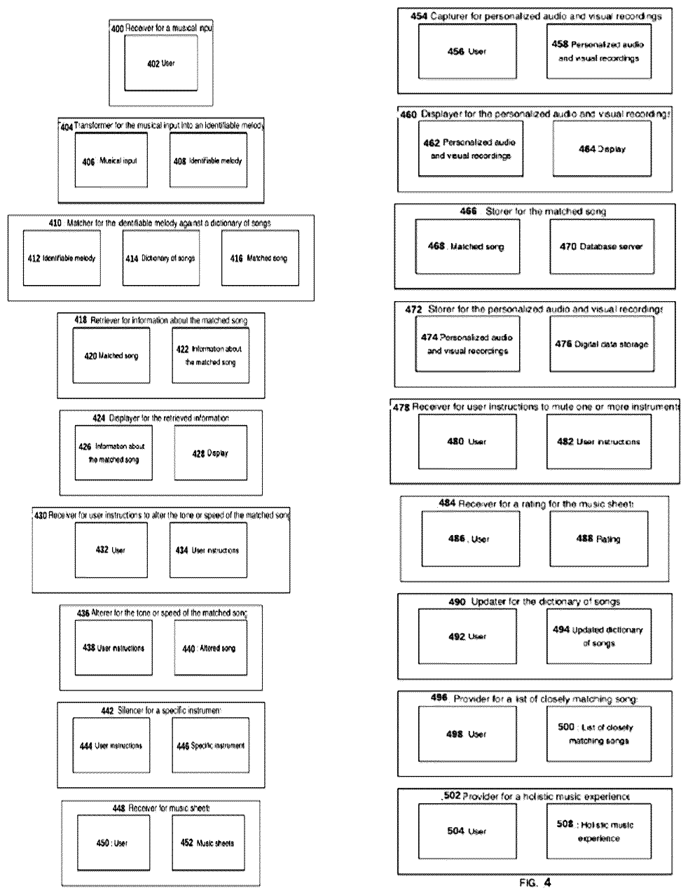

Now, a further detailed description of the disclosure is provided below in FIG. 4 below which illustrates systems and methods of the disclosure herein. The devices and methods to be employed are not limited by this list but what is suitable in a particular implementation, including deploying suitable software components in suitable hardware.

As provided in FIG. 4 above a block diagram describes various aspects of an embodiment. The music recognition software component is designed to provide a comprehensive music experience for users, which could be music students, music teachers, musicians, or music enthusiasts. The software embodying systems and methods of the disclosure herein is equipped with a receiver component (400) that takes in a musical input from the user. This could be a hummed tune or a played song. The receiver then passes this musical input to a transformer component (404), which uses a unique identification algorithm to convert the musical input into an identifiable melody. A couple of exemplary algorithms that may fit this process include: AcousticID or EchoPrint.

This identifiable melody is then matched against a dictionary of songs stored in the cloud by a matcher component (410). The dictionary of songs could be stored in various cloud storage systems such as the common ones like the Amazon S3, Google Cloud Storage, or Microsoft Azure Storage. Once a match is found, a retriever component (416) retrieves information about the matched song, including the title of the song, the performer or group of performers, and the associated instruments. This information is then displayed on a device by a displayer component (424). The device could be a laptop, desktop, smartphone, tablet, or smart TV screen.

The software embodying systems and methods of the disclosure herein also allows the user to alter the tone or speed of the matched song. A receiver component (430) receives user instructions to alter the tone or speed of the matched song. An alterer or a modifying component (436) then uses an AI engine, such as TensorFlow, PyTorch, or Keras, to alter the tone or speed of the matched song based on the received user instructions. Other AI engines may also be deployed such as machine learning, supervised learning, unsupervised learning, reinforcement learning, weak and strong AI, GAN, AGI, NN, Computer Vision, NLP, and like in the systems and methods described in this disclosure.

In addition to altering the tone or speed of the song, the software embodying systems and methods of the disclosure herein also allows the user to mute a specific instrument in the song. A silencer component (442) receives user instructions to silence a specific musical device and then removes the frequencies associated with the specific instrument to mute it.

The software embodying systems and methods of the disclosure herein also provides a platform for users to upload music sheets. A receiver component (448) receives music sheets submitted by the user. These music sheets could be guitar tablature, piano sheet music, violin sheet music, drum sheet music, or flute sheet music. The music sheets are then stored in a database server by a storer component (422). The database server could be any compatible database such as MySQL, PostgreSQL, MongoDB, Oracle Database, or Microsoft SQL Server.

The software embodying systems and methods of the disclosure herein also has a feature for capturing personalized audio and visual recordings. A capturer component (454) uses an online voice recorder. Examples include Vocaroo, Online Voice Recorder, or SpeakPipe to capture personalized audio and visual recordings. These recordings are then displayed to people around the world by a display component (460).

The software embodying systems and methods of the disclosure herein also has a feature for storing the modified song based on inputs from the user (466)

The software embodying systems and methods of the disclosure herein also allows the user to rate the mute one or more instruments. A receiver component (478) receives an instruction to mute one or more instruments.

The software embodying systems and methods of the disclosure herein also allows the user to rate the music sheets. A receiver component (484) receives a rating for the music sheets from the user. This rating is used to determine the credibility of the music sheets.

The software embodying systems and methods of the disclosure herein also updates the dictionary of songs based on the musical input received from the user. An updater component (490) updates the dictionary of songs based on the musical input received from the user.

The software embodying systems and methods of the disclosure herein also provides a list of closely matching songs when the identifiable melody does not match any song in the dictionary. A provider component (496) provides a list of closely matching songs to the user.

Finally, the software embodying systems and methods of the disclosure herein provides a holistic music experience for the user. A provider component (FIG. 4: 502) provides a holistic music experience for the user. This could be a music student, a music teacher, a musician, or a music enthusiast. The holistic music experience includes recognizing the song, retrieving information about the song, altering the tone or speed of the song, muting a specific instrument in the song, uploading music sheets, capturing personalized audio and visual recordings, displaying the personalized audio and visual recordings, storing the matched song, storing the personalized audio and visual recordings, receiving user instructions to mute one or more instruments, receiving a rating for the music sheets, updating the dictionary of songs, providing a list of closely matching songs, and providing a holistic music experience.

The process begins with a music enthusiast providing a musical input, which could be a hummed tune or a played song. This input is received through a microphone on a device, such as a smartphone. The unique identification algorithm, which could be a fingerprinting algorithm, then transforms this musical input into an identifiable melody. This involves converting the song into a spectrogram, which is a visual representation of the spectrum of frequencies of the song as they vary with time. The spectrogram is then transformed into a sequence of numbers or digitized data.

The identifiable melody is then matched against a dictionary of songs stored in a cloud, such as the Google Cloud Storage. This dictionary contains a vast collection of songs, and the matching process involves comparing the digitized data of the identifiable melody with the digitized data of the songs in the dictionary. Once a match is found, information about the matched song is retrieved. This information includes the title of the song, the performer or group of performers, and the associated instruments.

The retrieved information is then displayed on a device, such as a laptop, desktop, or handheld device. This allows the music enthusiast to see the details of the song they hummed or played. The music enthusiast can then provide instructions to alter the tone or speed of the matched song. These instructions are received by the application, and the tone or speed of the matched song is altered based on these instructions using an AI engine, such as TensorFlow or any other compatible neural network engine, or advanced AI engine, such as a Large Language Model or the like.

The music enthusiast can also instruct the application to silence a specific instrument. This is accomplished by removing the frequencies associated with the specific instrument from the song. The music enthusiast can also submit music sheets, which are received by the application. These music sheets provide written music that can be used to learn or play the song.

The application also has an inbuilt recording feature, which allows the music enthusiast to capture personalized audio and visual recordings using an Online Voice Recorder on a Smartphone. These recordings can include the music enthusiast singing or playing along with the track of the matched song. Finally, these personalized audio and visual recordings are displayed to people around the world. This allows the music enthusiast to showcase their performances to a global audience.

The process begins with a musical input component, which is the initial sound or tune provided by a music enthusiast. This input is then processed by the unique identification algorithm component, which is a unique algorithm designed to transform the musical input into an identifiable melody. This involves converting the song into a spectrogram, which is a visual representation of the spectrum of frequencies of the song as they vary with time. The spectrogram is then transformed into a sequence of numbers or digitized data.

The identifiable melody is then matched against a dictionary of songs component, which is a vast collection of songs stored in the cloud, such as the Google Cloud Storage component. Cloud Storage is a storage service that provides a secure and scalable storage solution for the dictionary of songs. Once a match is found, the information about the matched song component retrieves the details of the song, including the title of the song, the performer or group of performers, and the associated instruments.

The retrieved information is then displayed on a device component, which could be a laptop, desktop, or handheld device. This allows the music enthusiast to see the details of the song they hummed or played. The User Instruction Receiver component then receives instructions from the music enthusiast to alter the tone or speed of the matched song. These instructions are processed by the TensorFlow component, which is an AI engine that alters the tone or speed of the matched song based on the received user instructions.

The specific instrument component is then silenced based on user instructions. This is accomplished by removing the frequencies associated with the specific instrument from the song. The Music sheets component then receives music sheets submitted by the user. These music sheets provide written music that can be used to learn or play the song.

The personalized audio and visual recordings component captures personalized audio and visual recordings using the online voice recorder on smartphone components. This component is an online voice recorder that records custom audio and videos. Finally, these personalized audio and visual recordings are displayed to the People around the world component, which represents a global audience. This allows the music enthusiast to showcase their performances to a global audience.

### Exemplary User Interface in Mobile Device

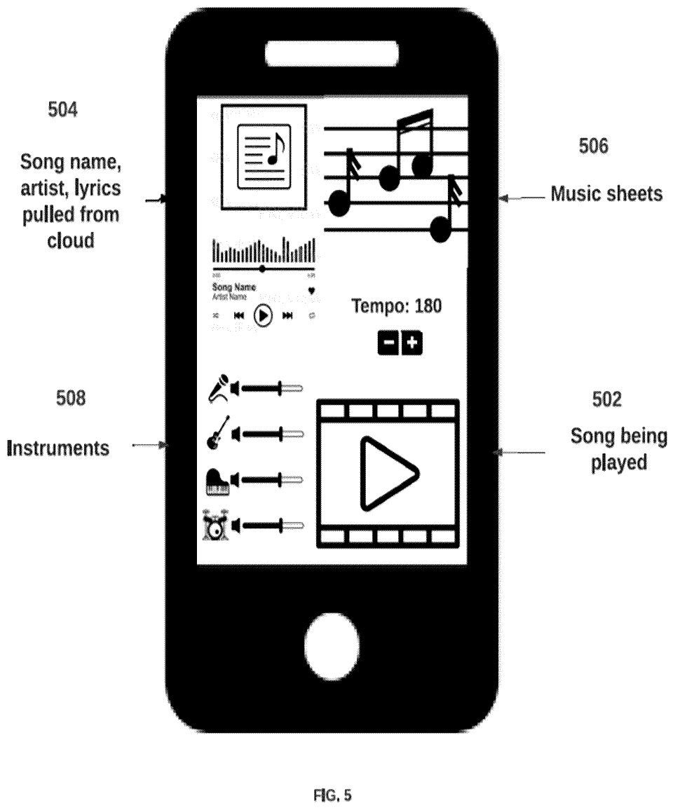

FIG. 5 below provides exemplary user interface (UI) components in accordance with certain embodiments of systems and methods of the disclosure herein. Of course, the arrangement of the various aspects of the UI may be varied to best suit the real estate available on the screen or device.

The front end of the UI interface has a song that is being played (502), list of details around the song such as singer, movie name/album name (504), music sheets (506), and the list of instruments that can be potentially muted. Additional details may also be added and varied to suit the requirements of the application embodying systems and methods of the disclosure. Thus, a larger tablet or computer device screens may have significantly more UI features and details.

### Exemplary System

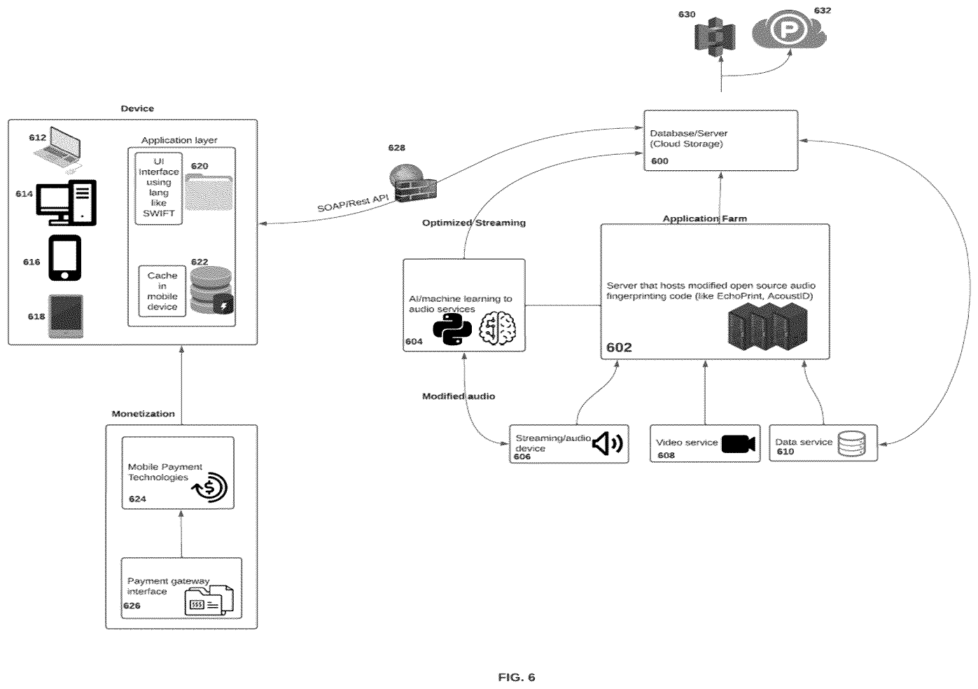

FIG. 6 above illustrates systems and methods of the disclosure herein, by providing a schematic diagram of the various technological processes performed in the components of the software embodying systems and methods of the disclosure herein in accordance with certain embodiments. The devices and methods to be employed are not limited by this list but what is suitable in a particular implementation, including deploying suitable software components in suitable hardware. All the songs and information related to the song is stored in a database server (600). Some of the commercially available cloud storage solutions such as Amazon or pCloud are listed in 630 and 632. The User Interface is typically written in a programming language such as Swift (620). The fingerprinting algorithm that determines the song match resides in the application farm (602). The fingerprinting algorithm may be an open source algorithm, such as from EchoPrint or AcoustID or the likes of it. If there is no match, the algorithm searches in a commercially available source such as YouTube to get a list of closely matching songs. The user can choose the appropriate song and this information will be updated in the database. The deep learning algorithm is designed to provide a very high success search rate of a list of songs while searching through YouTube. Once the song details such as name, singer/s, list of instruments is retrieved using web services such as either simple object access protocol or representational state transfer, the application can cache this information and display it in the user interface. The software embodying systems and methods of the disclosure herein may be a paid service with a typical subscription service. To collect payment from the user, who can enter financial information either through a credit card or a mobile wallet. This payment processing is handled by 3rd party processors through the cloud. (624 and 626) SONG MODIFICATION

In the realm of music and audio processing, the ability to manipulate and modify songs is a crucial aspect. This includes altering various elements of a song such as its pitch and tempo. Pitch and tempo are fundamental components of a song that significantly influence its overall sound and feel.

Pitch shifting, in particular, is a complex process that involves the transformation of the song's frequency. This is typically achieved through the use of Fast Fourier Transforms (FFT), a mathematical algorithm that converts a signal from the time domain to the frequency domain. This conversion allows for the manipulation of the song's pitch.

However, pitch shifting is not without its challenges. For instance, different musical instruments such as percussion, guitar, and wind instruments, each have unique characteristics that can make pitch shifting a difficult task. Furthermore, the process of pitch shifting can sometimes result in unwanted artifacts such as reverberation.

In addition to pitch shifting, changing the tempo of a song is another common modification. Tempo refers to the speed or pace of a given piece of music, and altering it can drastically change the song's mood and style. However, similar to pitch shifting, changing the tempo of a song can be a complex process that requires careful manipulation of the song's elements.

Overall, while the modification of songs through pitch shifting and tempo changing is a valuable tool in music and audio processing, it is a complex process that presents several challenges.

There are two things a user can do to modify a song: change the pitch or change the tempo. Changing the pitch, as referred to commonly as Pitch Shifting is typically done in frequency domain (although from time to time we see people also using time domain pitch shifting given the ease of implementation, but comes with a downside of reverberation artifacts.) In the frequency domain method, the sample data/sound is first converted to frequency using Fast Fourier Transforms. Once FFT transforms time sampled data into complex amplitudes with equal frequencies, we do what we call phase unwrapping to break it down into a predefined set of frequencies. The final step is synthesizing that batches these predefined frequency bins and you inverse FFT to recreate the original song with modified pitching algorithms. The stretching exercise is very difficult for different instruments such as Percussion or Guitar or other wind instruments.

The Transformation is an effective and simple implementation of Discrete Fourier Transform that converts signal from time domain to frequency domain. The DFT is given by

$$X ( k ) = {{\sum }_{n = 0}}^{N - 1} x ( n ) {e}^{( - 2 kn π j ) / N} \\ K = 0 , 1 , … , N - 1$$

The DFT translates or breaks down to coefficients corresponding to frequency bins. Once phase unwrapping is done, the inverse FFT is done as follows

$$x ( n ) = 1 / N {{\sum }_{{n = 0}^{}}}^{N - 1} X ( k ) {e}^{( 2 kn π j ) / N} \\ K = 0 , 1 , … , N - 1$$

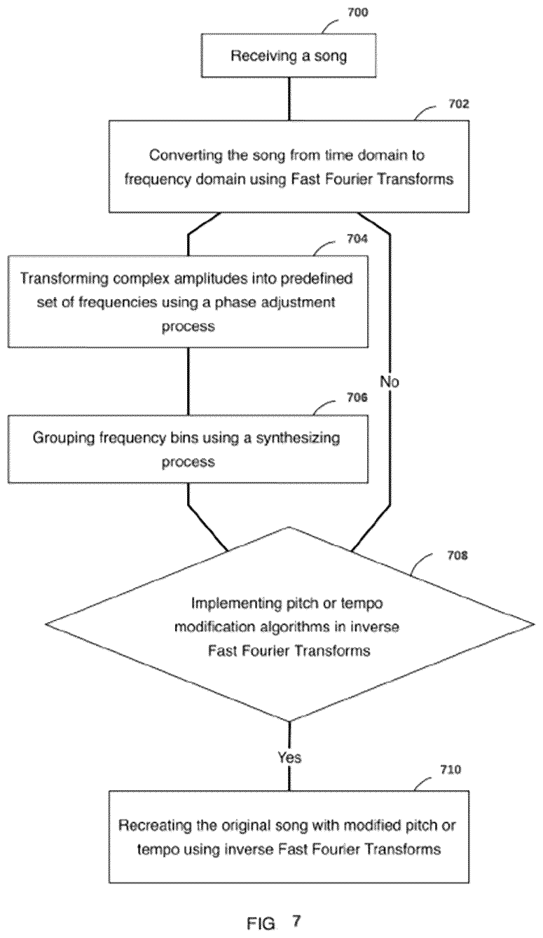

A flow chart below in FIG. 7 illustrates exemplary aspects of achieving song modification. The devices and methods to be employed are not limited by this list but what is suitable in a particular implementation, including deploying suitable software components in suitable hardware.

In the first step (700), a melody, such as a symphony or a ballad, is received. This can be done by a music producer, a DJ, or a music software developer, for instance. The melody could be received in various formats such as a digital audio file, a vinyl record, or a live performance. The input to this step is the melody and the output is the melody ready for processing.

In the second step (702), the melody is converted from the temporal domain to the spectral domain using spectral transformation methods such as Discrete Fourier Transform (DFT), Short-time Fourier Transform (STFT), or Wavelet Transform (WT). This step allows the individual or entity to manipulate the melody in the frequency domain, which is easier and more efficient. The input to this step is the melody in the time domain and the output is the melody in the frequency domain.

In the third step (704), the spectral components of the melody are decomposed into specific spectral elements using a phase adjustment process. This could be done using phase reconstruction, phase recovery, or phase estimation. This step allows the individual or entity to manipulate specific frequencies of the melody. The input to this step is the melody in the frequency domain and the output is the melody with its frequencies decomposed.

In the fourth step (706), the specific spectral elements are grouped using an audio reconstruction process such as mixing, blending, or combining. This step allows the individual or entity to reconstruct the melody with the modified frequencies. The input to this step is the melody with its frequencies decomposed and the output is the melody with its frequencies grouped.

In the fifth step (708), pitch or tempo modification algorithms such as Auto-tune, Melodyne, or Waves Tune are implemented in reverse spectral transformation methods such as Inverse Discrete Fourier Transform (IDFT), Inverse Short-time Fourier Transform (ISTFT), or Inverse Wavelet Transform (IWT). This step allows the individual or entity to modify the pitch or tempo of the melody. The input to this step is the melody with its frequencies grouped and the output is the melody with its pitch or tempo modified.

In the final step (710), the original melody is recreated with the modified pitch or tempo using reverse spectral transformation methods. This could be done using IDFT, ISTFT, or IWT. This step is crucial as it allows the individual or entity to listen to the modified melody. The input to this step is the melody with its pitch or tempo modified and the output is the modified melody ready for playback.

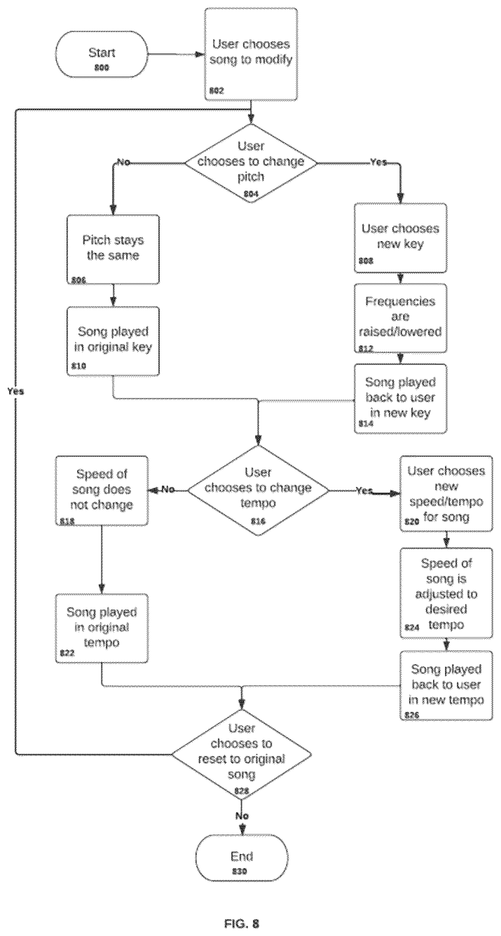

In another exemplary embodiment shown in FIG. 8, a flow chart is provided describing various aspects of the disclosure below.

As described in FIG. 8 above, various steps of aspects of the disclosure embodying systems and methods are further described in the flowchart to modify a song:

In step 802, the user asks to look up the list of songs saved under the user's profile in the app. This is enabled by a database search of the entire list of songs that the user has downloaded or made favorite in his/her account. If the user has done a keyword search, only the songs that match the search criteria are displayed on the app. The option to modify the song is made from the menu options on the app display. The user chooses a song that needs to be modified from his list of songs in the app; for example, may modulate the tempo or the pitch of the song.

In step 804, if the user did not choose to modify the pitch of the song, the pitch of the song will remain unchanged irrespective of any changes to other aspects of the song (808).

In step 806, if the user chooses not to change the pitch, the song will be played back in the original pitch of the song that was saved as the default parameters of the song profile (810).

In step 812, if the user chooses to change the pitch, a list of options for changes in pitch are provided on the client side app, and the user chooses a pitch to which the song has to be replayed.

In step 814, if the user chose a higher pitch, the requested pitch is sent to the app server. The AI engine will look up the number pattern that matches the higher frequency from the database and send it back to the app. If the user chooses a lower pitch, the requested pitch is sent to the app server. The AI engine will look up the number pattern that matches the lower frequency from the database and send it back to the app. ML will blend the modified number pattern to the rest of the song number pattern and send the modified song to the app. The app will play the modified song back to the user on the interface.

In step 816, if the user chooses the option to modify the temp of the song from the menu options on the app.

In step 818, if the user does not choose to modify the tempo of the song, the speed of the song will remain unchanged irrespective of any changes to other aspects of the song.

In step 822—Song will be played back in the original speed of the song that was saved as the default parameters of the song profile.

In step 820, from the list of options for changes in tempo that are built into the app, the user chooses a tempo to which the song has to be replayed.

In step 824, if the user chooses a higher or a lower tempo, the requested speed is sent to the app server. The AI engine will modify the interval between the number pattern to adjust to the new requested tempo and send it back to the app. ML will blend the modified number pattern to the rest of the song number pattern and send the modified song to the app.

In step 826, the song is played back in a new tempo on the app.

In step 828, the app will play the modified song back to the user on the interface and if the user chooses to reset the song to the original tempo, it will remain as the original. If the user chooses the option to go back to original parameters of the song, the request is sent to the database server and the song with original number pattern sequence is sent to the app server and the app will play the song with the original or default parameters.

In step 830, the process ends.

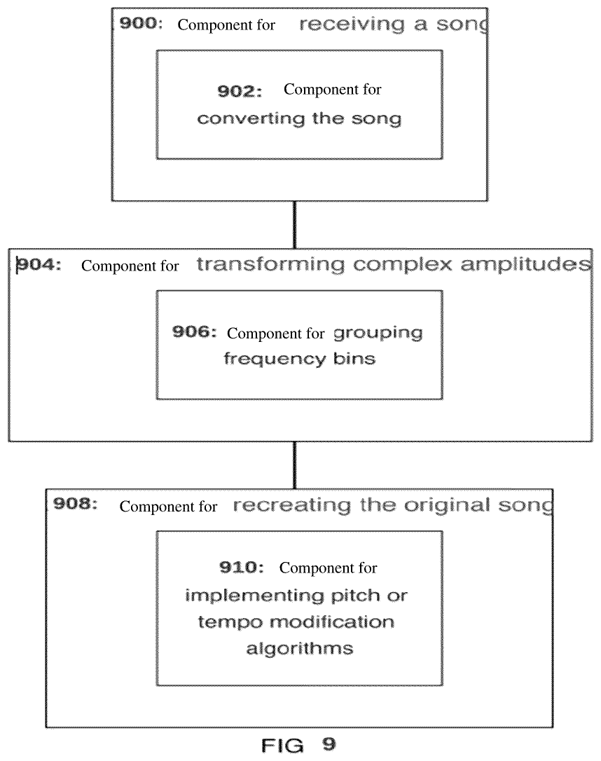

A further embodiment of systems and methods of the disclosure herein is described in a block diagram below in FIG. 9 which further describes this process and the components (e.g., hardware including processor(s) and/or software) or means of various aspects of the subject matter. The components (e.g., hardware including processor(s) and/or software) or means described in the block diagram may include servers, client computers, handheld smart devices, smartphones, and other devices in communication with each other. An embodiment of the disclosure may include a system for modifying audio content, comprising: components (e.g., hardware including processor(s) and/or software) or means for receiving one or more audio signals; components (e.g., hardware including processor(s) and/or software) or means for transforming the audio signals from a temporal domain to a spectral domain using one or more spectral transformation methods; components (e.g., hardware including processor(s) and/or software) or means for decomposing spectral components into specific spectral elements using a phase adjustment process; components (e.g., hardware including processor(s) and/or software) or means for grouping specific spectral bins using an audio reconstruction process; components (e.g., hardware including processor(s) and/or software) or means for reconstructing original audio content with altered audio property using reverse spectral transformation methods; components (e.g., hardware including processor(s) and/or software) or means for implementing audio alteration algorithms in reverse spectral transformation methods; components (e.g., hardware including processor(s) and/or software) or means for modifying the audio content which includes artificial intelligence technologies. The devices and methods to be employed are not limited by this list but what is suitable in a particular implementation, including deploying suitable software components in suitable hardware.

Once you receive the song for modification, the specific spectral elements are then grouped together by the frequency bins (900). The technique of modifying existing bins can require modifying complex amplitudes (904). This audio reconstruction process, could be mixing, blending, or combining, batches the frequency bins together. The grouped spectral bins are then used to reconstruct the original audio content with altered audio property by the next component (908). This reverse spectral transformation method, which could be Inverse Discrete Fourier Transform, Inverse Short-time Fourier Transform, or Inverse Wavelet Transform, recreates the original song with modified pitch or tempo.

Finally, the last component (910) implements audio alteration algorithms like Pitch correction software embodying systems and methods of the disclosure herein, Auto-tune, or Melodyne in the reverse spectral transformation methods to modify the pitch or tempo of the song. This results in the final modified song, which has been altered according to the preferences of the individual or entity. The system is designed to handle audio content from various musical instruments, such as piano, violin, or flute, making it versatile and adaptable to different types of audio content.

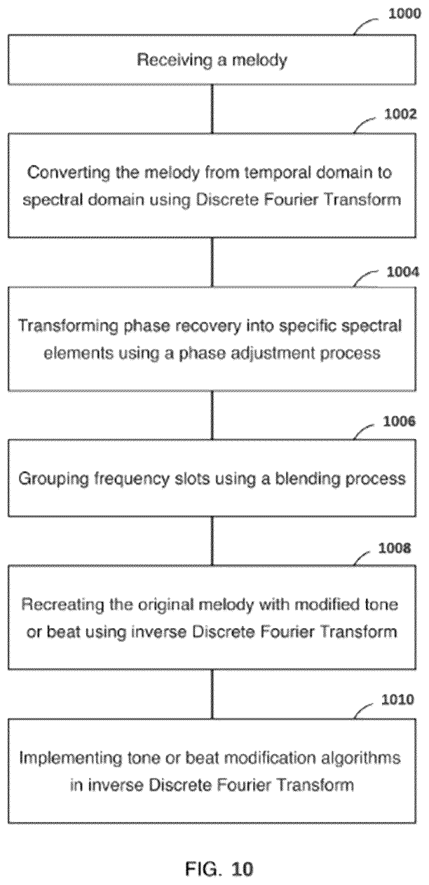

A block diagram below in FIG. 10 illustrates systems and methods of the disclosure herein which further describes this process of various aspects of certain embodiments. The devices and methods to be employed are not limited by this list but what is suitable in a particular implementation, including deploying suitable software components in suitable hardware.

The process begins with receiving a melody (1000). This involves an individual or entity, such as a music producer or musician, selecting a specific piece of audio content, such as a song or tune, to be modified. The selected melody is then converted from the temporal domain to the spectral domain using a Discrete Fourier Transform (1002). This transformation process involves the use of spectral transformation methods, such as Fast Fourier Transforms (FFT), to change the audio data from its original time-based format into a frequency-based format. This allows for more precise manipulation of the audio content's properties, such as pitch and tempo.

Once the melody has been transformed into the spectral domain, the next step involves transforming phase recovery into specific spectral elements using a phase adjustment process (1004). This process involves decomposing the spectral components of the audio data, such as complex amplitudes, into a predefined set of frequencies or spectral elements. This is done using a phase adjustment process, such as phase unwrapping, which breaks down the complex amplitudes into their constituent frequencies.

The specific spectral elements are then grouped together using a blending process (1006). This involves grouping specific spectral bins, such as frequency slots or channels, together in a way that allows for the desired modifications to the audio content's properties to be made. This process is known as synthesizing and involves the use of audio reconstruction processes to group the spectral bins together.

The original melody is then recreated with a modified tone or beat using an inverse Discrete Fourier Transform (1008). This involves reversing the spectral transformation process to convert the audio data back into the time domain, while also implementing the desired modifications to the audio content's properties. This is done using inverse spectral transformation methods, such as Inverse FFT, and involves reconstructing the original audio content with the altered pitch or tempo.

Finally, tone or beat modification algorithms are implemented in the inverse Discrete Fourier Transform (1010). This involves the use of audio alteration algorithms, such as pitch shifting or tempo modification algorithms, to make the desired modifications to the audio content's properties. These algorithms are implemented in the inverse spectral transformation process to ensure that the modifications are accurately reflected in the recreated melody.

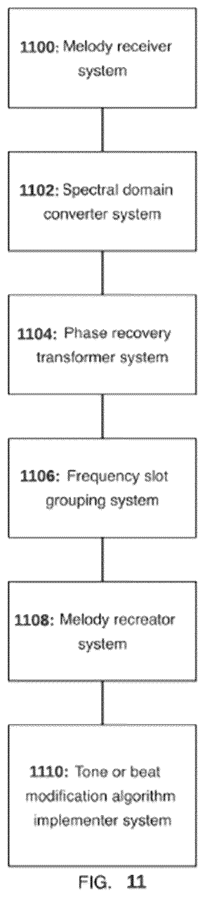

A block diagram below in FIG. 11 further describes systems and methods of the disclosure herein various aspects of certain embodiments. The devices and methods to be employed are not limited by this list but what is suitable in a particular implementation, including deploying suitable software components in suitable hardware.

The Melody receiver system (1100) is the initial component of the system. It is responsible for receiving the melody that is to be modified. This involves an individual or entity, such as a music producer or musician, selecting a specific piece of audio content, such as a song or tune, to be modified. The output of this system is the received melody, which is then passed on to the next component of the system.

The Spectral domain converter system (1102) takes the received melody as its input. This system is responsible for converting the melody from the temporal domain to the spectral domain using a Discrete Fourier Transform. This transformation process involves the use of spectral transformation methods, such as Fast Fourier Transforms (FFT), to change the audio data from its original time-based format into a frequency-based format. This allows for more precise manipulation of the audio content's properties, such as pitch and tempo. The output of this system is the melody in the spectral domain, which is then passed on to the next component of the system.

The Phase recovery transformer system (1104) takes the melody in the spectral domain as its input. This system is responsible for transforming phase recovery into specific spectral elements using a phase adjustment process. This process involves decomposing the spectral components of the audio data, such as complex amplitudes, into a predefined set of frequencies or spectral elements. This is done using a phase adjustment process, such as phase unwrapping, which breaks down the complex amplitudes into their constituent frequencies. The output of this system is the transformed phase recovery, which is then passed on to the next component of the system.

The Frequency slot grouping system (1106) takes the transformed phase recovery as its input. This system is responsible for grouping frequency slots using a blending process. This involves grouping specific spectral bins, such as frequency slots or channels, together in a way that allows for the desired modifications to the audio content's properties to be made. This process is known as synthesizing and involves the use of audio reconstruction processes to group the spectral bins together. The output of this system is the grouped frequency slots, which is then passed on to the next component of the system.

The Melody recreator system (1108) takes the grouped frequency slots as its input. This system is responsible for recreating the original melody with a modified tone or beat using an inverse Discrete Fourier Transform. This involves reversing the spectral transformation process to convert the audio data back into the time domain, while also implementing the desired modifications to the audio content's properties. This is done using inverse spectral transformation methods, such as Inverse FFT, and involves reconstructing the original audio content with the altered pitch or tempo. The output of this system is the recreated melody with the modified tone or beat, which is then passed on to the final component of the system.

The Tone or beat modification algorithm implementer system (1110) takes the recreated melody with the modified tone or beat as its input. This system is responsible for implementing the tone or beat modification algorithms in the inverse Discrete Fourier Transform. This involves the use of audio alteration algorithms, such as pitch shifting or tempo modification algorithms, to make the desired modifications to the audio content's properties. These algorithms are implemented in the inverse spectral transformation process to ensure that the modifications are accurately reflected in the recreated melody. The output of this system is the final melody with the implemented modifications.

### Instrument Muting

This is by far the most complex step in the process. To mute an instrument requires a multitude of steps and understanding of what makes up a song. A song is made of vocal and musical instruments played at a certain melody, chord and pitch. While the human ear can decipher any audibility between 20 Hz and 20 KHz, it is important to split the songs into a number of frequency bins using Fast Fourier Transforms. Fast Fourier Transforms or FFT as it is popularly called is mainly used to identify the composition of any signal. For example, if we play the keystrokes of Piano, it easily associates a frequency for each of the notes A, B, C etc. Coming back to the main song, One set of bins for vocals and another set of bins for instruments. Now each instrument plays the sound at a certain frequency. For example, the frequency of tenor sax is different from alto and which in turn is different from guitar. Once we identify the frequency range, we remove them to mute the instrument of interest and put back the frequency bins together using inverse FFT. This phenomenon of splicing is critical to the process of muting. Now the question is “how to remove the frequency” ?While below 3 dB frequencies can be removed using a low pass filter such as Butterworth filter, for frequencies in the audibility range, you use a method called sweeping where you can generate frequencies and keep tuning up or down until you hit the right frequency and this causes resonance. This resonant frequency can be eliminated using dynamic equalizer. This is how muting can be accomplished. The above set of actions can be achieved in a software embodying systems and methods of the disclosure herein with customized coding on a Python Library such as Librosa.

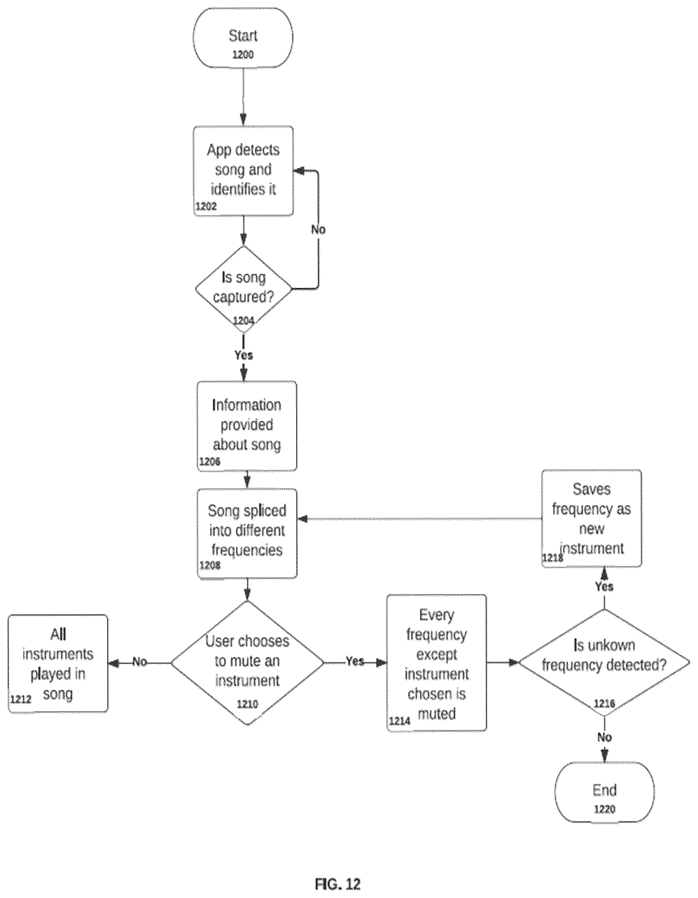

FIG. 12 illustrates, systems and methods of the disclosure herein in the form of a flowchart, the operations for muting an instrument using splicing, filtering and sweeping in accordance with certain embodiments. The devices and methods to be employed are not limited by this list but what is suitable in a particular implementation, including deploying suitable software components in suitable hardware. In step 1202, when the user hums a song, the app learns the song and identifies the song.

In step 1204, the software embodying systems and methods of the disclosure herein tries to match it with a song in the database. Once the song is recognized, the information and other details for the song such as singer, music sheets, instruments is retrieved in step 1206.

In step 1208, the song is spliced into different frequencies which are dependent on the musical instrument. Once the instruments in the song are determined, check boxes are provided for each instrument indicating which instruments are playing in the original song. In step 1210, if the user unchecks a box in the app, the particular instrument is muted.

In step 1212, if the user does not choose to mute an instrument, the entire piece is played as is with all the instruments.

In step 1214, if the user chooses a single instrument, then all other frequencies associated with other instruments are muted and the app only plays the chosen instrument. In step 1216, a determination is made whether an unknown frequency is detected.

In step 1218, this new piece with only the chosen frequency or frequencies is/are saved and the piece is stored in the database for future reference.

### Music Sheet Uploading

Music sheets are uploaded as is by the users for an instrument piece. Every time a user searches a music sheet using a search algorithm that is Search Engine Optimized, the music sheets are retrieved and the user can verify the accuracy and load it back. Verified music sheets have higher credibility and show up on top of the search list.

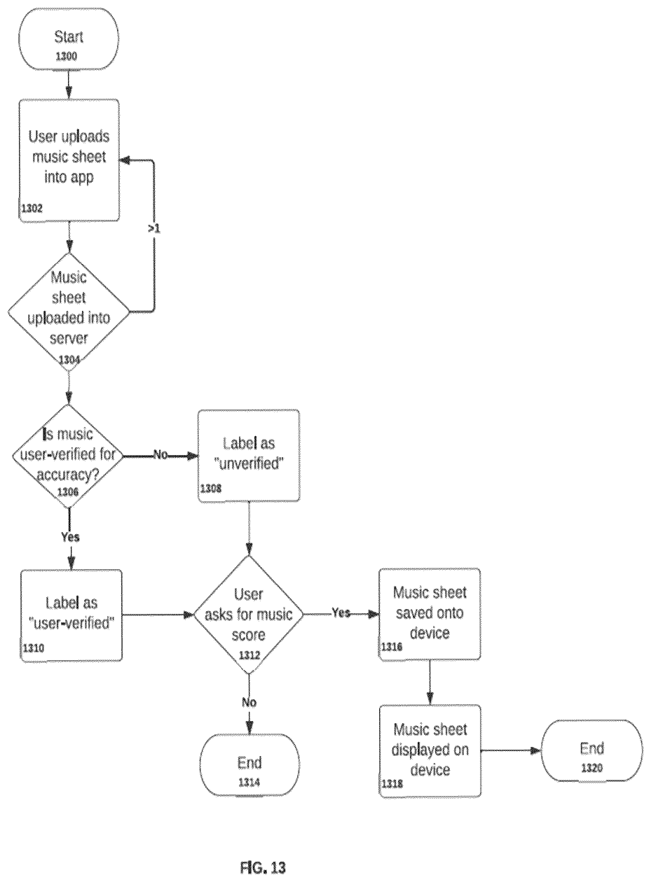

FIG. 13 above, illustrates systems and methods of the disclosure herein, in a flowchart, the operations for uploading a music sheet that is verified by a user in accordance with certain embodiments. The devices and methods to be employed are not limited by this list but what is suitable in a particular implementation, including deploying suitable software components in suitable hardware. In step 1302, the user uploads music sheets into the app to be stored in the database/server. In step 1304, if there are multiple sheets/instruments, each is loaded one at a time.

In step 1306, if the music sheets are not verified they are stored in the server with the label “unverified.” In step 1308, if the music sheets are unverified, then they are labeled as ‘unverified.’

In step 1310, a music sheet is labeled as ‘verified’ by the user notation. In step 1312, the user is prompted for rating the music sheet for a score between 1-10. In step 1314, if scoring is not done, then the process ends and the music sheet is ready to be saved on the device.

In step 1316, if the user enters a score, both the verified label and score towards the music sheet is uploaded, rendering credibility for future reference; and the music sheet is displayed on the device (1318). And the process ends here (1320)

### Song Recording

Here the learner pulls the music sheet, original track from the cloud storage, and mutes the instrument that he wants to play and plays his instrument on top of the customized song. This can be recorded using an online voice recorder and stored back in the server. Users on retrieval can rate the accuracy and this builds the confidence in an individual and motivates an individual to record more custom audio and videos for others to access and learn.

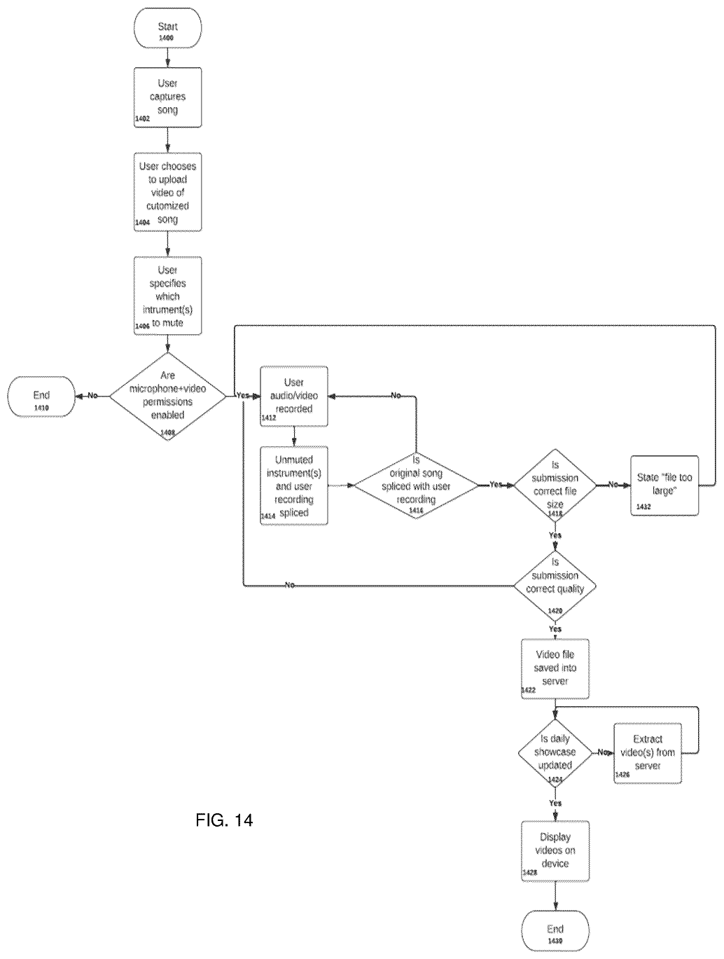

FIG. 14 illustrates, illustrates systems and methods of the disclosure herein, in a flowchart, the operations for recording a song with instrument of choice mixed in accordance with certain embodiments. The devices and methods to be employed are not limited by this list but what is suitable in a particular implementation, including deploying suitable software components in suitable hardware.

In step 1402, the user captures the song from a source. In step 1404, the user makes a choice to use the customized option for video/audio upload of the song. In step 1406, the user specifies which instruments to mute, once the captured song is listed with its instruments. The user may also choose to mute the vocal.

In step 1408, a determination is made if the microphone and camera permissions are enabled for the song. If they are not enabled, nothing can and needs to be done, and the step ends there as revealed in stem 1410.

In step 1412, if permission is enabled, then they are turned on and a recording of the relevant pieces of the composition may be overlaid with external voice and/or instrument

In step 1414, the unmuted instruments and the user recording are spliced in.

In step 1416, a determination is made if the original song is spliced in with the user recording. In step 1418, a determination is made, once the recording is made to ensure that the file or document size is within acceptable limits for an upload, which is typically about 25 MB, but may vary depending on the system. In step 1432, if the file or document size is higher than the acceptable limit, an instruction is provided, record again.

In step 1420, a determination is made if the recording is of sufficient quality. In step 1422, if the recording is of sufficient size/or quality, the file is uploaded to a server.

In step 1422, the video server determines if the daily showcase information is updated for future reference. In step 1424, if the daily showcase information is not updated, then the file is extracted. In step 1426, if the daily show case information is updated, the videos are available for display on the device.

In step 1428, the video displayed on the device and the process ends at 1430.

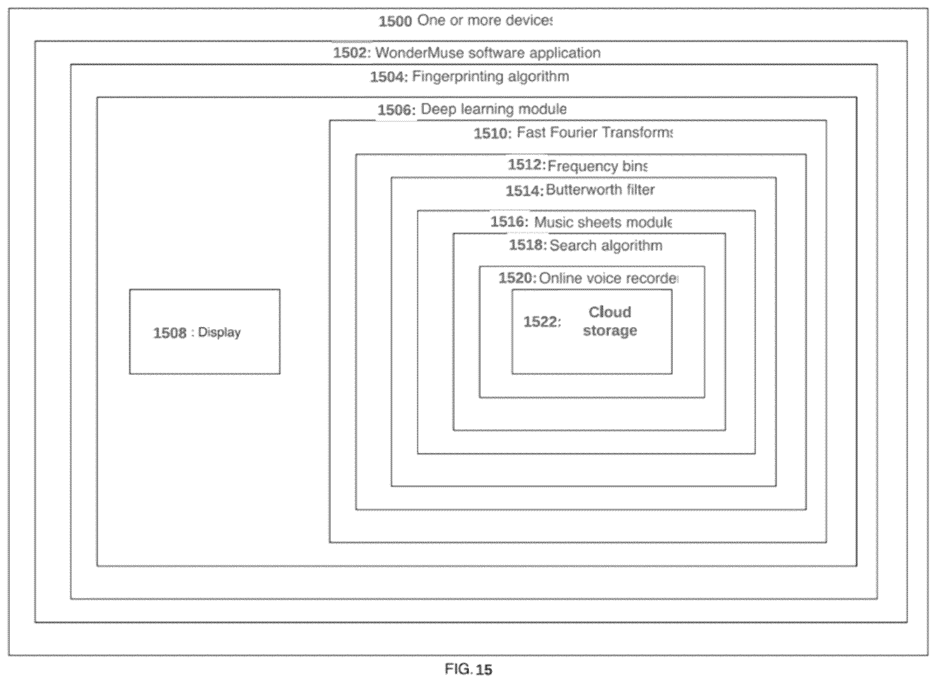

In FIG. 15 below, illustrates systems and methods of the disclosure herein, another embodiment, including a computer implemented system. The devices and methods to be employed are not limited by this list but what is suitable in a particular implementation, including deploying suitable software components in suitable hardware.

This embodiment is a computer-implemented system that provides a holistic music experience. It begins with a user, who could be a music enthusiast, musician, or music student, providing a musical input through electronic equipment such as a laptop, desktop, or handheld device (1500). This musical input could be a hummed tune or a played song. The device then transfers this musical input to the software embodying systems and methods of the disclosure herein (1502), a music recognition and modification software embodying systems and methods of the disclosure herein.

The software embodying systems and methods of the disclosure herein receives the musical compositions and employs a fingerprinting algorithm (1504), which could be an open source algorithm like EchoPrint or AcoustID. This algorithm which is an AI based deep learning algorithm transforms the musical composition into a visual representation of frequencies, known as a spectrogram (1506). The spectrogram is then transformed into numerical data or digitized information using deep learning techniques.

The numerical data is then compared with a database of musical compositions stored in a digital storage system in a public or private cloud storage. The results of this comparison, which include the musical sequences and musical composition information, are displayed on a visual output device (1508) such as a computer monitor or smartphone screen.

The system also includes a feature for modifying the tone of the musical composition using Fast Fourier Transforms (1510), a frequency analysis technique. This process, known as Pitch Shifting, transforms the time sampled data into complex amplitudes with equal frequencies. These frequencies are then organized into ranges of frequency bins (1512).

To mute specific musical devices in the musical composition, a Butterworth filter (1514), a type of frequency filter, is used. This filter eliminates certain frequency ranges, effectively muting the corresponding musical devices.

The system also allows users to submit written music or music sheets (1516) through a music sheets module. This module uses a data retrieval method or search algorithm (1520) that is search-friendly or Search Engine Optimized to obtain the written music.

Finally, the system includes an online voice recorder (1522), a web-based audio capture tool, that allows users to capture and submit audio with the musical composition. This captured audio is then stored in the digital storage system, in a public or private cloud storage

In summary, the embodiments described herein are of a comprehensive music system that allows users to provide musical input, identifies and displays the musical composition information, modifies the tone of the musical composition, mutes specific musical devices, allows users to submit written music, and records and stores the audio with the musical composition. It uses a variety of components and techniques including a device, the software embodying systems and methods of the disclosure herein, a fingerprinting algorithm, deep learning, a display, Fast Fourier Transforms, frequency bins, a Butterworth filter, a music sheets module, a search algorithm, an online voice recorder, and a digital storage system.

The process begins with a music enthusiast humming, singing, or playing a song into a Smartphone. This musical input is received by the software embodying systems and methods of the disclosure herein, a specialized music recognition and modification software. The software then employs a Shazam algorithm, a music identification algorithm, to transform the song into a visual representation of frequencies, known as a spectrogram. This spectrogram visually represents the different frequencies present in the song, with the vertical axis representing frequency and the horizontal axis representing time.

The spectrogram is then transformed into Music information using deep learning, a machine learning technique that uses artificial neural networks to mimic the way the human brain works. This transformation process involves analyzing the spectrogram and extracting key features such as the pitch, tempo, and rhythm of the song.

The Music information is then compared with a database of musical compositions stored in a Cloud/digital storage system. This comparison process involves matching the extracted features of the song with the features of songs in the database to identify a match.

Once a match is found, the musical sequences and musical composition information of the song are displayed on a device screen. This information includes the song title, artist name, album name, and lyrics.

The tone of the song is then modified using Fast Fourier Transforms, a mathematical algorithm that transforms a function of time into a function of frequency. This allows the Music enthusiast to change the pitch or key of the song to suit their preference.

Low frequency ranges are then generated using frequency bins, which are small ranges of frequencies. Certain Low frequency ranges are then eliminated to mute specific Guitar in the song using a Low-pass Butterworth filter, a type of signal processing filter that removes frequencies above a certain cutoff frequency.

The Music enthusiast then submits music sheets to upload, which is a written representation of the song. This Sheet music uploading is obtained using a Linear search algorithm, a simple search algorithm that checks every element in the database until a match is found. The Music enthusiast then captures and submits audio with the song using an online voice recorder. This audio recording is then stored in Cloud for future reference.

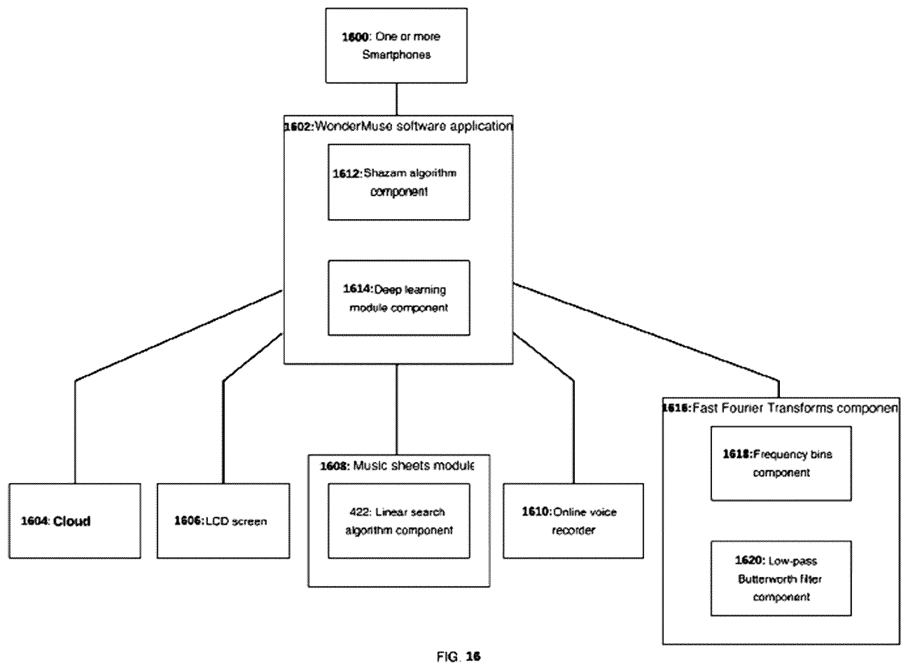

Another flow chart provided in FIG. 16 below illustrates systems and methods of the disclosure herein, which embodies various aspects of an exemplary embodiment including a deep learning AI engine. Here an LCD screen is disclosed but any other commercially feasible device and screen may be deployed. The devices and methods to be employed are not limited by this list but what is suitable in a particular implementation, including deploying suitable software components in suitable hardware.

The system begins with one or more smartphones, or another device (1600), which are used by Music enthusiasts to provide a song as a musical input. These Smartphones are equipped with microphones and audio processing capabilities to capture and digitize the musical input.

The software embodying systems and methods of the disclosure herein (1602) is a specialized music recognition and modification software that receives the musical compositions. It employs an algorithm component (1612) to transform the song into a visual representation of frequencies, known as a spectrogram. This algorithm is capable of analyzing the audio data and extracting the unique fingerprint of the song.

The software embodying systems and methods of the disclosure herein also includes a deep learning module component (1614) that transforms the visual representation of frequencies into Music information. This module uses artificial neural networks to analyze the spectrogram and extract key features such as the pitch, tempo, and rhythm of the song.

The cloud component (1604) is a digital storage system that stores a database of musical compositions. This cloud storage is used to store and retrieve the Music information for comparison with the database of musical compositions.

The LCD or other suitable screen component (1606) is used to display the musical sequences and musical composition information. This screen provides a visual interface for the Music enthusiasts to interact with the system and view the results of the music recognition and modification process.

The Fast Fourier Transforms component (1616), Frequency bins component (1618), and Low-pass Butterworth filter component (1620) are used to modify the tone of the song and mute specific Guitar in the song. The Fast Fourier Transforms component transforms the time-domain audio signal into the frequency domain, the Frequency bins component generates Low frequency ranges, and the Low-pass Butterworth filter component eliminates certain Low frequency ranges.

The Music sheets module component (1608) allows Music enthusiasts to submit Sheet music uploading. This module provides an interface for the users to upload written music for the song.

The Linear search algorithm component (1622) is used to obtain the Sheet music uploading. This algorithm searches through the database of sheet music to find a match for the uploaded music.

The online voice recorder component (1610) allows Music enthusiasts to capture and submit audio with the song. This component provides an interface for the users to record their voice along with the song and submit the audio recording to the system.

Finally, the captured audio is stored in the cloud component (1604) for future reference. This cloud storage provides a secure and accessible storage solution for the audio recordings.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage.

Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operate by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize that many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multi thread execution capability; multi-core processors; multi-core processors with software multi thread execution capability; multi-core processors with hardware multithread technology; parallel platforms; and parallel platforms with distributed shared memory. Additionally, a processor can refer to a graphic processing unit (GPU), an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units. It should be further understood that the components (e.g., hardware including processor(s) and/or software) or means that perform the functions described herein can be various types of computing devices as described herein.

As used herein, terms such as “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

As used herein, at its simplest form, artificial intelligence (AI) is a field, which combines computer science and robust datasets, to enable problem-solving. It also encompasses sub-fields of machine learning and deep learning, which are frequently mentioned in conjunction with artificial intelligence. These disciplines are comprised of AI algorithms which seek to create expert systems which make predictions or classifications based on input data. Artificial intelligence has gone through many cycles, and now with the release of OpenAI's ChatGPT there is a turning point. Generative AI is now the leap forward in natural language processing. The disclosure herein contemplates the use of all forms of AI: machine learning, supervised learning, unsupervised learning, reinforcement learning, weak and strong AI, GAN, AGI, NN. Computer Vision, NLP, and like.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such a term is intended to be inclusive in a manner similar to the term “comprising” as “comprising” is interpreted when employed as a transitional word in a claim. In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a a further example of indirect coupling, an action in a first item can cause a reaction on the second item, as a result of actions and/or reactions in one or more intervening items.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

Such embodiments of the subject matter may be referred to herein, individually and/or collectively, by the term “invention”, merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. Section 1.72(b), requiring an abstract that will allow the display to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, disclosed subject matter lies in less than all features of a single disclosed embodiment. Thus, the following claims are hereby incorporated into the Detailed Description, with each claim standing on its own as a separately claimed subject matter.

1. A computer-implemented method for providing a holistic music experience, the method comprising:
receiving, by a processing system including a processor, a musical input from a user;
transforming, by the processing system, the musical input into an identifiable melody using a unique identification algorithm;
matching, by the processing system, the identifiable melody against a database of musical compositions stored in a digital storage space resulting in a matched musical composition;
retrieving, by the processing system, information about the matched musical composition, wherein the information includes a title of the musical composition, a performer, an associated musical device, or a combination thereof;
displaying, by the processing system, the retrieved information on a visual output device;
receiving, by the processing system, user instructions to alter at least one of a tone or speed of the matched musical composition;
altering, by the processing system, the at least one of the tone or speed of the matched musical composition based on the received user instructions;
silencing, by the processing system, a specific musical device based on the received user instructions;
receiving, by the processing system, written music submitted by the user;
capturing, by the processing system, personalized audio and visual recordings using an integrated recording feature; and
displaying, by the processing system, the personalized audio and visual recordings.

2. The computer-implemented method of claim 1, wherein the unique identification algorithm generates a spectrogram by applying an artificial intelligence process.

3. The computer-implemented method of claim 1, wherein the altering of the at least one of the tone or speed includes adjusting a duration, pitch, intensity, and timbre of at least a portion of the matched musical composition.

4. The computer-implemented method of claim 1, comprising providing, by the processing system, the personalized audio and visual recordings to a platform that is accessible to one or more end user devices.

5. The computer-implemented method of claim 1, wherein the altering and the silencing result in an adjusted musical composition, and further comprising combining, by the processing system, the personalized audio and visual recordings with the adjusted musical composition resulting in a personalized adjusted musical composition.

6. The computer-implemented method of claim 5, comprising providing, by the processing system, the personalized adjusted musical composition to a platform that is accessible to one or more end user devices.

7. An apparatus, the apparatus comprising:
a processing system including a processor; and
a memory that stores executable instructions that, when executed by the processing system, facilitate performance of operations, the operations comprising:
receiving one or more audio signals;
transforming the audio signals from a temporal domain to a spectral domain using one or more spectral transformation methods;
decomposing spectral components into specific spectral elements using a phase adjustment process;
grouping specific spectral bins using an audio reconstruction process;
reconstructing original audio content with altered audio property using reverse spectral transformation methods; and
implementing audio alteration algorithms in the reverse spectral transformation methods.

8. The apparatus of claim 7, wherein the one or more audio signals include an auditory input from a user, and wherein the operations further comprise:
identifying a song from the auditory input using a fingerprinting algorithm; and
providing details of the identified song including at least one of a song name, a singer's name, or a listing of instruments being played in the song.

9. The apparatus of claim 7, wherein the altered audio property includes changing pitch, changing key, or changing tempo.

10. The apparatus of claim 7, wherein the altered audio property includes instrument muting.

11. The apparatus of claim 7, wherein the operations further comprise:
recording and uploading voice with track;
applying deep learning to identify a song from auditory input; and
converting the song into a spectrogram using a fingerprinting algorithm.

12. The apparatus of claim 7, wherein the operations further comprise capturing and displaying personalized audio and visual recordings, wherein the altered audio property includes at least one of adjusting a duration, pitch, intensity, and timbre of at least a portion of the original audio content.

13. The apparatus of claim 12, wherein the operations further comprise providing the personalized audio and visual recordings to a platform that is accessible to one or more end user devices.

14. A non-transitory machine-readable medium, comprising executable instructions that, when executed by a processing system including a processor, facilitate performance of operations, the operations comprising:
receiving an auditory input from a user;
identifying a song from the auditory input using a fingerprinting algorithm;
providing details of the identified song including at least one of a song name, a singer's name, or a listing of instruments played during the song; and
adjusting the song including at least one of changing a pitch, changing a key, or changing a tempo resulting in an adjusted song.

15. The non-transitory machine-readable medium of claim 14, wherein the operations further comprise muting an instrument being played during the song.

16. The non-transitory machine-readable medium of claim 14, wherein the operations further comprise retrieving a music sheet for the adjusted song.

17. The non-transitory machine-readable medium of claim 16, wherein the operations further comprise capturing personalized audio and visual recordings using an integrated recording feature; and
displaying the personalized audio and visual recordings.

18. The non-transitory machine-readable medium of claim 17, wherein the operations further comprise providing the personalized audio and visual recordings to a platform that is accessible to one or more end user devices.

19. The non-transitory machine-readable medium of claim 16, wherein the operations further comprise combining the personalized audio and visual recordings with the adjusted song resulting in a personalized adjusted song.

20. The non-transitory machine-readable medium of claim 19, wherein the operations further comprise providing the personalized adjusted song to a platform that is accessible to one or more end user devices.
